(19) United States
(12) Patent Application Publication
(10) Pub. No.: US 2004/0221101 A1
(43) Pub. Date: Nov. 4, 2004

(54) Automated media management

(75) Inventors: Bruce Voorhees, Cincinnati, OH (US); Dale Miller, Lebanon, OH (US)

Correspondence Address: VAN PELT & YI LLP, 10050 N. FOOTHILL BLVD #200, CUPERTINO, CA, 95014, US

(73) Assignee: EMC Corp.

(21) Appl. No.: 10/737,715

(22) Filed: Dec. 16, 2003

Related U.S. Application Data
(60) Provisional application No. 60/434,471, filed on Dec. 18, 2002.

(51) Int. Cl. G06F 12/00

(52) U.S. Cl. 711/111; 711/162

(57) ABSTRACT

Managing media in an environment comprising two or more library, device, or host types is disclosed. A media management request not specific to any library, device, or host type is sent to an agent installed at a host. The agent is configured to receive the request and act thereon in the manner required by the particular library, device, and/or host implicated by the request.

### CROSS REFERENCE TO RELATED APPLICATIONS

This application claims priority to U.S. Provisional Patent Application No. 60/434,471 entitled Automated Media Management filed Dec. 18, 2002, which is incorporated herein by reference for all purposes.

Co-pending U.S. patent application No. ______(Attorney Docket No. LEGAPO13) entitled Automated Media Library Configuration, filed concurrently herewith, is incorporated herein by reference for all purposes; and co-pending U.S. Pat. application Ser. No. ______(Attorney Docket No. LEGAP014) entitled Resource Allocation Aware Queuing of Requests for Media Resources, filed concurrently herewith, is incorporated herein by reference for all purposes.

### FIELD OF THE INVENTION

The present invention relates generally to removable storage media. More specifically, automated media management is disclosed.

### BACKGROUND OF THE INVENTION

Fully or partially automated media libraries, sometimes referred to herein as “libraries” or “robots”, are available to store and manipulate removable storage media, such as tapes used to store computer data for backup or archive purposes. A typical library may be equipped with a robotic or other mechanism for manipulating the media stored therein, such as by inserting a selected volume or unit of the media (e.g., a particular tape) into a read/write device associated with the unit, e.g., a tape drive configured to write data to and/or read data from the media. In the computer network environment, e.g., a backup application may be used to store data from one or more computers or other devices connected to the network (sometimes referred to herein as network “nodes” or “hosts”) on storage media associated with a library.

For a large network, or in cases in which nodes on the network use a variety of different applications and/or hardware platforms, or where the nature of the data is diverse, or simply as a result of separate purchasing decisions being made over time and/or by separate subsets of the group of users served by the network, it is possible to have two or more different backup applications in place. For similar reasons, a particular network may have associated with it more than one library, possible of different types, and a plurality of storage devices associated with each library. In addition, the hosts associated with the various storage devices may be connected to those devices in different ways, and the hosts themselves may be of different platform types (e.g., different operating systems).

Given this potential diversity, there is a need for a straightforward and efficient way to manage removable storage media resources (e.g., libraries and their associated tapes and storage devices) across backup applications (and other applications that may require media access), library types, device types, and host types.

### BRIEF DESCRIPTION OF THE DRAWINGS

Various embodiments of the invention are disclosed in the following detailed description and the accompanying drawings.

FIG. 1 is a block diagram illustrating one exemplary embodiment of a network environment and an automated media management system.

FIG. 2 illustrates a common interface for controlling different types of library.

FIG. 3 is a flow chart illustrating a process used in some embodiments to configure hosts to enable a media manager to control libraries and devices of different types using a common interface.

FIG. 4 illustrates a process used in some embodiments by a media manager to establish communication with a host.

FIG. 5 is a flow chart illustrating a process used in some embodiments to control different types of library and device using a common interface.

FIG. 6 is a flow chart illustrating a process used in some embodiments to respond to a common interface request received from a media manager.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and invention may be practiced according to the claims without some or all of these specific details. For the purpose of clarity, technical material that is known in the technical fields related to the invention has not been described in detail so that the invention is not unnecessarily obscured.

Automated media management is disclosed. In particular, managing media in an environment comprising two or more library, device, and/or host types is disclosed. A media management request using a common interface not specific to any library, device, or host type is sent to an agent installed at a host associated with at least a subset of the media being managed. The agent is configured to receive the request and act thereon in the manner required by the particular library, device, or host implicated by the request.

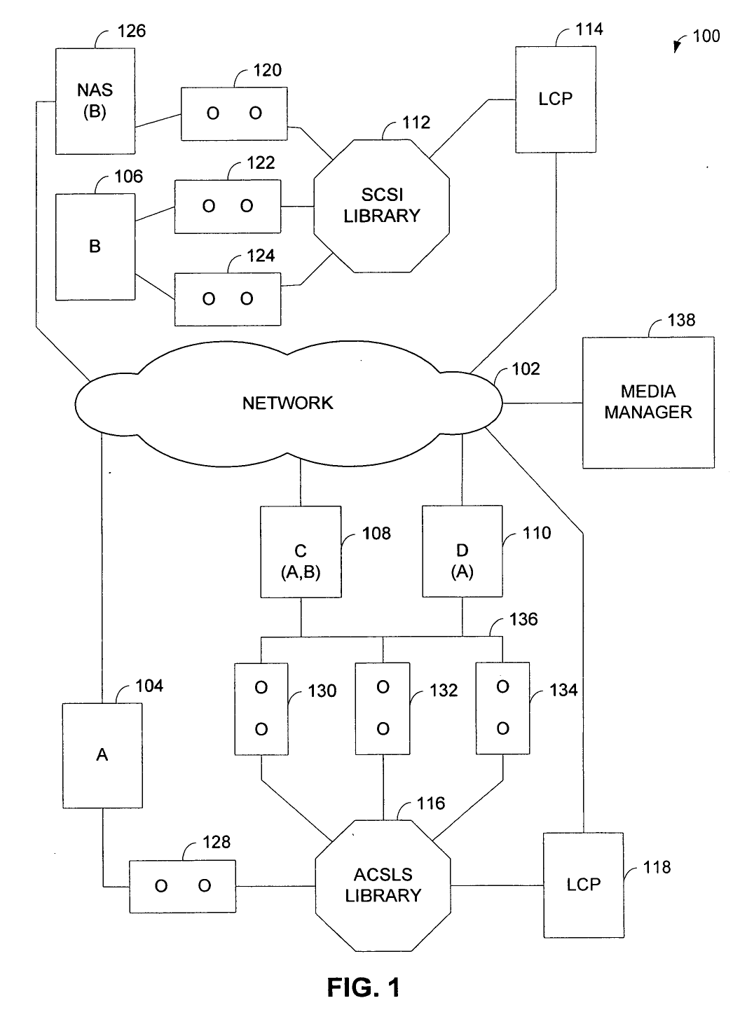

FIG. 1 is a block diagram illustrating one exemplary embodiment of a network environment and an automated media management system. The system 100 comprises a network 102, which may be a local area network (LAN) or any type of private or public network. The system 100 further comprises servers A, B, C, and D, identified by reference numerals 104, 106, 108, and 110, respectively, in FIG. 1, connected to network 102. In the example shown in FIG. 1, a first backup application, such as the NetWorker backup application available commercially from the Legato Software Division of EMC Corporation, is installed on server A (104), and a second backup application is installed on server B (106). The first and second backup applications may be the same or different products. The data on server C (108) is backed up by both the first backup application installed on server A (104) and the second backup application installed on server B (106), as is indicated in FIG. 1 by the letters “A” and “B” in parentheses below the letter “C”. Such a configuration may be used, e.g., to provide two independent backups for particularly critical data. Server D (110) is backed up by the first backup application installed on server A (104). Server A may likewise comprise a body of data that is backed up by operation of the first backup application installed on server A, and server B may comprise a body of data that is backed up by operation of the second backup application installed on server B. The storage media used by the first and second backup applications installed on servers A and B, respectively, reside in two storage media libraries of different types. SCSI library 112 is a library configured to be controlled directly by a library host 114 via a small computer systems interface (SCSI) connection. Library host 114 is connected to SCSI library 112 and to network 102. ACSLS library 116 is an automated cartridge system library software-controlled library of the type available commercially from StorageTechnology Corporation (StorageTek) of Louisville, Colo. An ACSLS-type library such as library 116 is controlled using a software controller provided for that purpose, as opposed to being controlled directly by the library host. Library host 118 is connected to and configured to control ACSLS library 116. Library host 118 also is connected to network 102. While examples of a SCSI and ACSLS type library are shown in FIG. 1, any number of combination of types of libraries may be used, including without limitation IBM 3494, ADIC AML, and/or any other type of library. SCSI library 112 has associated with and connected to it tape drives 120, 122, and 124. Tape drive 120 is connected to a network attached storage (NAS) device 126. The data on NAS 126 is backed up by operation of the second backup application installed on server B. NAS 126 also has a connection to network 102. ACSLS library 116 has associated with and connected to it tape drives 128, 130, 132, and 134. Tape drive 128 is connected to server A. Tape drives 130, 132, and 134 are connected to servers C (108) and D (110) via a storage area network (SAN) 136. SAN 136 makes it possible for each of servers C and D to read from or write to any one of the SAN-connected tape drives 130, 132, and 134.

A media management application is installed on a media manager 138 to coordinate operations between the first backup application running on server A and the second backup application running on server B, such as by receiving and arbitrating between potentially competing requests for resources associated with libraries 112 and 116, as well as executed such requests. For example, the media manager may receive requests from the backup applications that a particular tape residing in one of the libraries be inserted into a tape drive associated with that library. The media management application may provide other functionality, such as keeping track of tapes stored in the libraries and elsewhere. The media manager 138 has a connection to the network 102, which it uses to communicate with other nodes connected to network 102 as described more fully below. The media manager 138 may comprise a server connected to network 102.

Each of servers A, B, C, and D may comprise different hardware and/or may be running a different operating system (or version thereof). In addition, the type of media stored in SCSI library 112 and ACSLS library 116 may vary. Also, certain elements may be connected to an associated tape device differently than others. For example, servers C and D are connected to tape drives 130, 132, and 134 via a SAN, while servers A and B may have direct SCSI connections to the tape drives to which they are connected. In one embodiment the NAS 126 is connected to tape drive 120 via the network data management protocol (NDMP). Under the NDMP protocol, an NDMP server installed on NAS 126 is configured to control the interaction of NAS 126 with tape drive 120. Applications requiring interaction with NAS 126 with respect to tape drive 120, such as the second backup application installed on server B, must comprise an NDMP client configured to send requests in the proper format to the NDMP server running on NAS 126.

To perform its functions, media manager 138 must be able to communicate with a variety of hosts, in some cases running different operating systems, to obtain information about and exercise control over a variety of storage devices (in this example, tape drives) that are connected to their associated hosts in a variety of different ways and that are associated with a variety of different types of libraries.

One approach to this problem would be to provide a way for media manager 138 to know the type and configuration of each host, device, and library associated with the media resources it is tasked with managing. For example, the media manager may receive a request from the first backup application running on server A to mount a particular volume of storage media (e.g., a particular tape) on a particular drive, in preparation for a backup or restore operation. To provide a specific example, the first backup application running on server A may request that the media manager case a tape ABC 123 in ACSLS library 116 be mounted in tape drive 130 to allow for the backup of data on server C to tape ABC123. One could configure media manager 138 to perform this operation by providing a way for media manager 138 to know (or determine from an information base) the platform type of server C (hardware, operating system, etc.), the nature of the connection between server C and tape drive 130 (in this case, via a SAN), and the fact that library 116 is an ACSLS type library. Media manager 138 could then send a request to library host 118 in the format appropriate to cause the library host 118 to control the library 116, using the ACSLS software, as required to cause the library 116 to mount tape ABC123 on tape drive 130. Media manager 138 could similarly be configured to send SCSI commands to SCSI library 112 (via library host 114). Media manager 138 could also comprise an NDMP client capable of communicating directly with NAS 126 and any other NDMP configured hosts. Such an approach would have a number of shortcomings. Someone would have to create and maintain the information base used by the media manager 138 to know how to communicate with each host with respect to each device or library, as applicable. Also, if a new type of library, host, device, or configuration were added to the system 100, in addition to updating the information base the media manager 138 would have to be updated to enable it to communicate with and control the new equipment. Such an update would have to be completed without disturbing the ability of the media manager 138 to interact with existing resources. In addition, media manager 138 would be unavailable to perform its functions during such reconfiguration.

The techniques described herein provide a more advantageous way of enabling media manager 138 to communicate with and control diverse types of resources. Instead of requiring that the media manager 138 be able to speak a plurality of languages, common elements of those languages are identified and a common interface defined based on those common elements. For example, regardless of type, all library system must be able to perform certain basic operations, such as providing a list of devices associated with the library, providing the library's device identifier for each such device, providing an inventory of tapes in the library, mounting (installing) a specified tape on a designated drive, removing a tape from a drive (sometimes referred to herein as “unmnounting” a tape), importing a tape to the library, exporting a tape from the library, moving a tape from one slot to another within the library, and providing an audit of tapes in the library without updating the library database. Likewise, regardless of device type, connection type, and host operating system, each host having a connection to one or more storage devices must be able to perform such functions with respect to devices to which it has a connection, such as providing a list of devices to which it is connected, providing a path on the host to each device (e.g., a device file), determining and reporting whether a particular device is on line, and causing a tape to be ejected from a device.

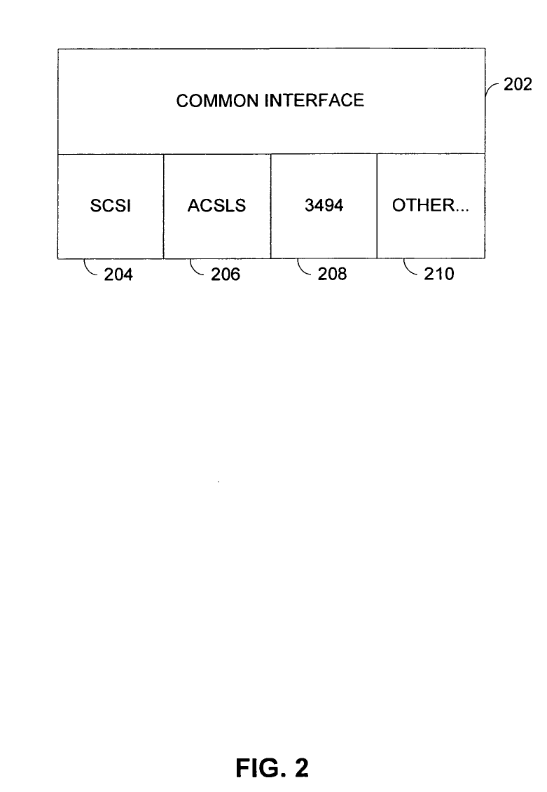

FIG. 2 illustrates a common interface for controlling different types of library. A common interface 202 is defined by extracting common elements from the respective type-specific interfaces defined for controlling each different type of library, such as a SCSI library interface 204, an ACSLS library interface 206, an IBM 3494 library interface 208, and/or any other type of library, as represented collectively by block 210. The common interface may similarly be defined to include a common interface for controlling different types of devices via different types of host.

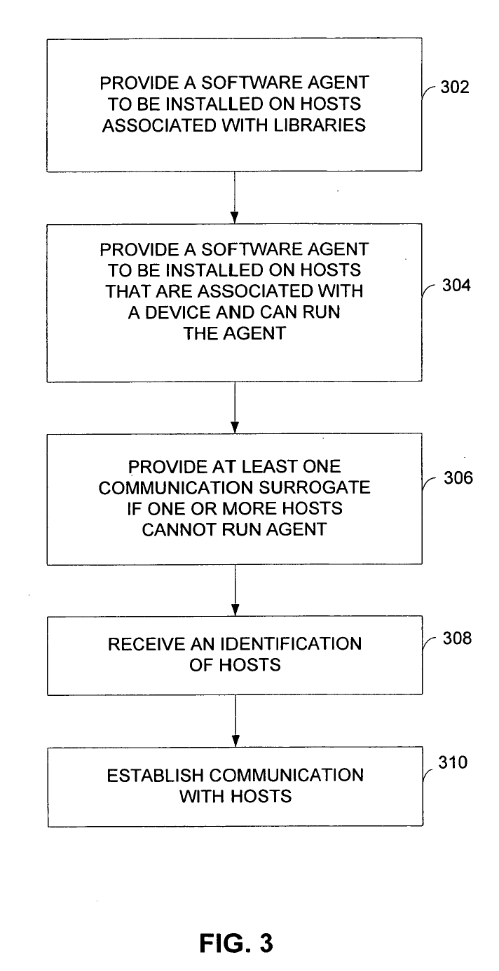

FIG. 3 is a flow chart illustrating a process used in some embodiments to configure hosts to enable a media manager to control libraries and devices of different types using a common interface. The process begins in step 302, in which a software agent that is to be installed on each host system configured to control a library to be managed by the media manager is provided. In some embodiments, the agent is configured to receive from the media manager a request under the common interface and translate that request into the form and content required for the particular library being controlled (e.g., SCSI, ACSLS, IBM 3494, ADIC AML, etc.) In some embodiments, the agent may comprise a library control program (LCP). In some embodiments, the LCP may through conditional compiles be configured to translate between the common interface and the type-specific interface for the library the host is configured to control. In some embodiments, the LCP may be configured to adapt to non-standard configurations, such as those that do not comply fully with an applicable standard (e.g., SCSI) in a way that results in information being received in unexpected format, e.g., with required data appearing in a response in a different place than expected. In some embodiments, the LCP is configured to adapt by consulting a matrix of known communications issues with the particular library being controlled and/or by considering one or more common communications problems.

In step 304, a software agent that is to be installed on each host system having a connection to a storage device (e.g., tape drive) associated with a library to be managed by the media manager is provided. In some embodiments, the agent is configured to receive from the media manager a request under the common interface described above and translate that request into the form and substance required for the particular device being controlled and/or the type of host. In some embodiments, the agent may comprise a drive control program (DCP). In some embodiments, the DCP may through conditional compiles be configured to translate between the common interface and the device and/or host type-specific interface required to control (or obtain required information from the host about) the device.

In step 306, at least one communication surrogate is installed on a system that is accessible via the network to the media manager if one or more hosts configured to control a library and/or having a connection to a storage device to be managed by the media manager cannot run the applicable software agent provided in steps 302 and 304. For example, the NDMP server described above is a closed system on which a software agent such as described above cannot run. For NDMP connected libraries and/or devices, then, a communications surrogate must be provided that will enable the media manager to control the library or device using the common interface by sending to the communications surrogate requests under the common interface, which the communications surrogate then translates into the corresponding NDMP request and sends to the NDMP server on the target host. The communications surrogate likewise must be configured to receive information from the NDMP server and provide the underlying data to the media manager in the format required or expected under the common interface. To perform this function, the surrogate must be configured to function as an NDMP client and must have the ability to communicate with the host on which the NDMP server resides over the network. In some embodiments, an LCP or DCP installed on a non-NDMP host may be configured to serve as the communications surrogate. In some embodiments, e.g., where all hosts are NDMP configured, an LCP or DCP configured to serve as an NDMP communications surrogate may be installed on a system that is not a library or device-connected host, such as on the server on which the media manager itself is running. In an environment in which no NDMP configured devices are present, step 306 may be omitted.

In step 308 of the process shown in FIG. 3, an identification of hosts is received. In some embodiments, a user may supply the identification of hosts via a user interface. In some embodiments, hosts may be identified all at once, or as they are configured, e.g., as an LCP or DCP is installed on each. In some embodiments, the hosts may be identified at any time, including prior to a DCP or LCP being installed on them (as appropriate). In step 310, the media manager establishes communication with each host.

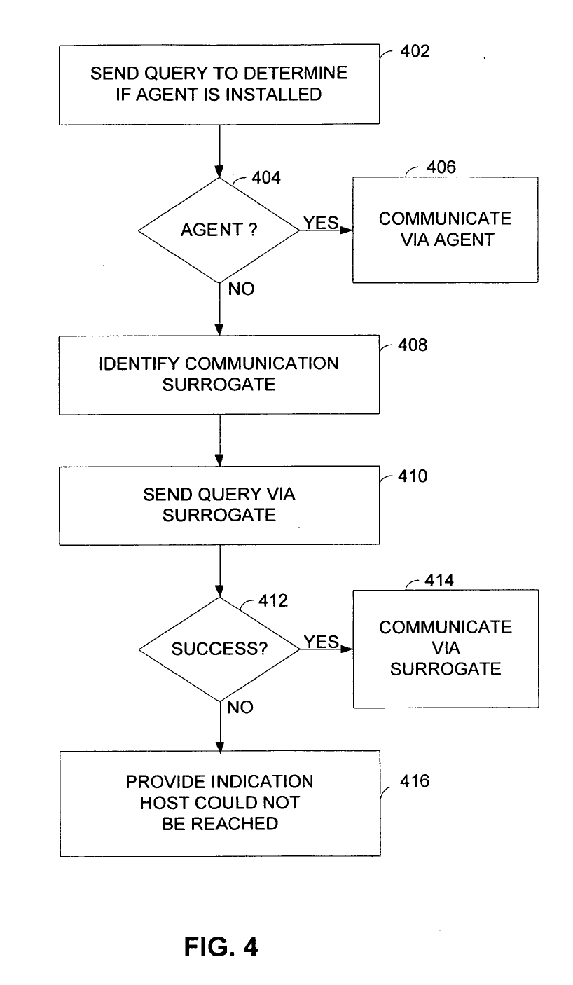

FIG. 4 illustrates a process used in some embodiments by a media manager to establish communication with a host. In some embodiments, step 310 of the process shown in FIG. 3 comprises completing the process shown in FIG. 4 with respect to each host. The process begins in step 402, in which a query is sent to the host to determine whether an agent is installed. In some embodiments, step 402 comprises sending a “hello” request to which an LCP or DCP, if installed, would respond. In step 404, it is determined whether or not a response was received from an agent installed on the host. If a response was received, the process proceeds to step 406 in which the media manager is configured to communicate with the host via the agent. In some embodiments, step 406 comprises setting a host type variable to a value indicating that an agent (e.g., LCP or DCP) is installed on the host. If it is determined in step 404 that no agent is installed, e.g., no response is received to a LCP/DCP “hello” request, the process advances to step 408, in which a surrogate for communications with the host is identified. In some embodiments, if an agent is not installed it is assumed that the host must be an NDMP configured host such that communication through a surrogate configured to act as an NDMP client is required. In some embodiments, a user may be provided an opportunity to designate, via a user interface, one or more candidates to serve as a communications surrogate for a particular NDMP configured host. Step 408 may comprise receiving such an identification of one or more candidates and determining which of them should be used as the surrogate. In step 410, a query is sent via the surrogate identified in step 408. Step 410 may comprise sending an NDMP “hello” request via the surrogate to determine whether an NDMP server is running on the host. In step 412, it is determined whether the attempt in step 410 to communicate with the host via the surrogate was successful. If the attempt was successful (e.g., a response to the NDMP “hello” request was received via the surrogate), the process proceeds to step 414 in which the media manager is configured to communicate with the host via the surrogate. If it is determined in step 412 that the attempt in step 410 was not successful, the process advances to step 416 in which an indication is provided that the host could not be reached. In some embodiments, the process shown in FIG. 4 may include additional steps, not shown, by which the media manager attempts to use one or more additional communication surrogate candidates to communicate with the host if the media manager is not able to communicate with the host via the surrogate identified in a previous iteration of step 408.

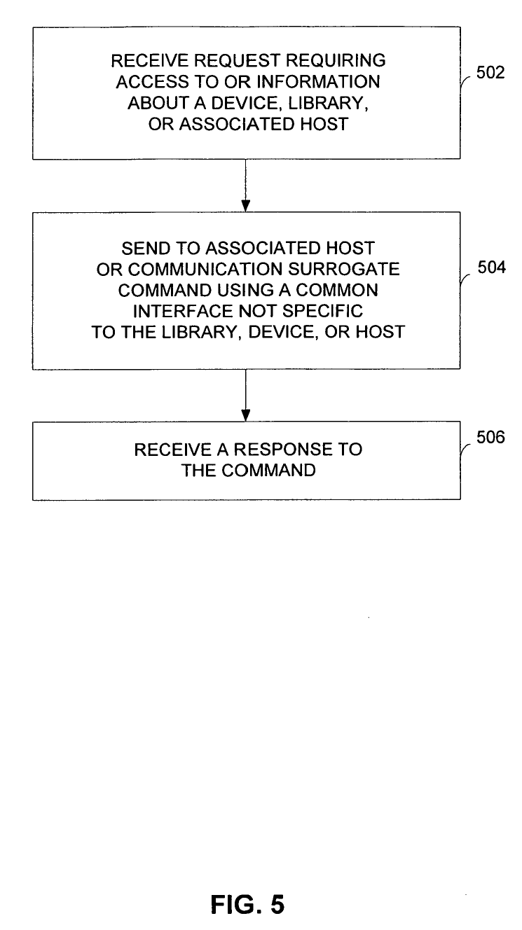

FIG. 5 is a flow chart illustrating a process used in some embodiments to control different types of library and device using a common interface. The process shown in FIG. 5 is implemented, for example, on a media manager such as media manager 138 of FIG. 1. The process begins in step 502 in which a request requiring access to or information about a device, library, or associated host is received. The request received in step 502 may be received from a remote host, such as a server on which a backup application is running (e.g., server A or server B in the example described above in connection with FIG. 1). The request may also be generated by a process associated with the media manager itself, such as a configuration process or a process associated with a command or request received from a user (e.g., via a user interface), e.g., a request for an audit of tapes in a library. In step 504, the media manager sends to the host to which the request relates (or the host associated with the library or device to which it relates) a command using a common interface not specific to the library, device, or host to which the request relates. The command sent in step 504 may be determined by the request received in step 502. For example, referring to the environment shown in FIG. 1 and described above, if the backup application running on server A sent a request to the media manager that tape WXY456 be installed in drive 130, e.g., for purposes of backing up data on server C, the media manager 138 may send a command under the common interface (e.g., “mount WXY456 on drive [name of the drive as it is known to the library ]”) to the library host 118. The LCP installed on host 118 would receive and generate in response to this command a control message in the format suitable for host 118 to cause the ACSLS software running on host 118 to control the library 116 as required to cause the designated tape to be installed on the designated drive. The LCP installed on host 118 may be further configured to determine when the required action has been completed and report back to the media manager as provided for under the common interface. In step 506 of the process shown in FIG. 5, the media manager receives such a response. A similar sequence of events would take place in the case of a request that requires action by a DCP-installed host associated with a device. In the case of an NDMP configured host, the request sent in step 504 using the common interface would be sent to a communications surrogate which would translate the request into the NDMP format and then send the NDMP request to the NDMP server running on the host associated with the library or device being controlled. In the case of some types of request, steps 502 and/or 506 may be omitted. The response received in step 506 may comprise an indication that a command has been executed, information requested by the command, or any other data responsive or otherwise related to the command.

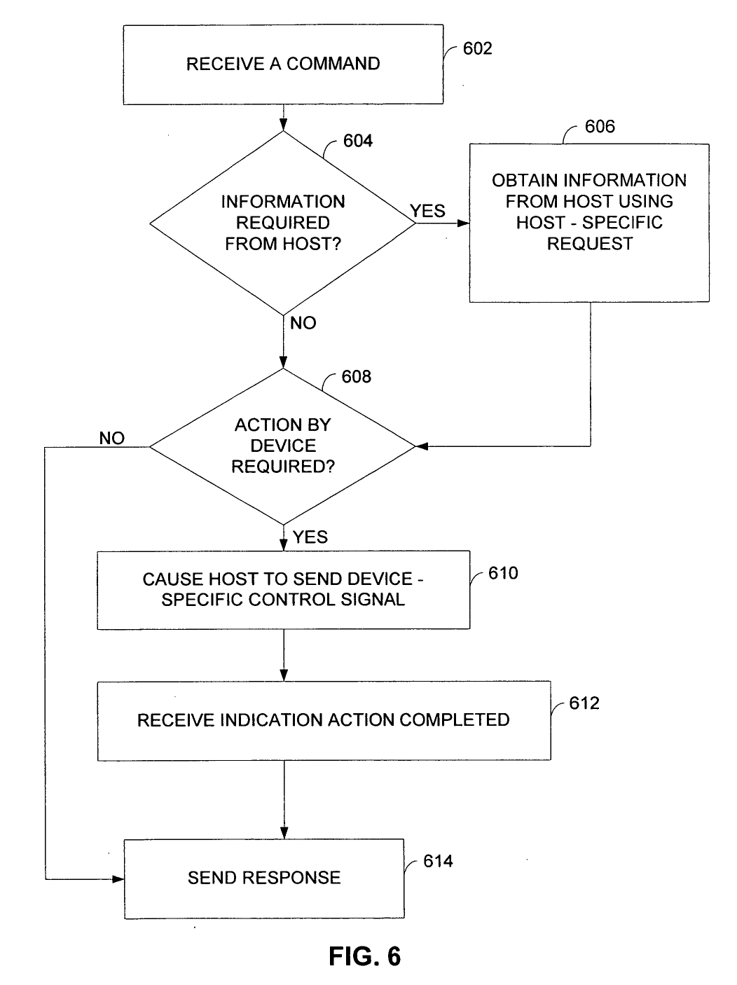

FIG. 6 is a flow chart illustrating a process used in some embodiments to respond to a common interface request received from a media manager. The process begins in step 602, in which a command under a common interface is received. In step 604, it is determined whether the command requires information from the host to which the command relates (e.g., the host on which an agent that received the request is installed, or a remote host with respect to which a communications surrogate that received the request is serving as surrogate). If it is determined in step 604 that information about the host is required, the process proceeds to step 606 in which the required information is obtained from the host using a host-specific request (e.g., one suitable for the host's operating system, or one under the NDMP protocol in the case of an NDMP configured host). Once the required information is obtained from the host in step 606, or if it is determined in step 604 that the command does not require information from or about the host, the process proceeds to step 608, in which it is determine whether any action by the device (or library, as applicable) is required. If it is determined in step 608 that no action by the device (or library) is required, the process proceeds to step 614, in which a response is sent to the media manager. An example of such a case is a command requiring a list of storage devices to which a host has a connection, which requires information from the host but no action by the device. If it is determined in step 608 that action by the device (or library) is required (e.g., tape eject in the case of a device, or tape mount or unmount in the case of a library), the process advances to step 610 in which the host is caused to send a device-(or library-) specific control signal to the device (or library) to cause the device (or library) to perform the required action. In step 612, an indication is received that the required action has been completed, after which the process advances to step 614 in which an appropriate response is sent to the media manager, using the common interface.

Using the techniques described herein, it would not be necessary to make any changes to the media manager if a new type of host, device, and/or library were added to an existing configuration, such as the one shown in FIG. 1. All that would be required would be to install on the host an agent configured to communicate with the media manager using the common interface and to translate commands received in the common format into the host-, library-, and/or device-specific commands required to be performed locally in response to the command received from the media manager. Using this approach, the media manager and previously installed components would not be affected by the addition of a new type of host, device, or library.

While the foregoing embodiments focus media management in the context of backup applications and computer networks, those of ordinary skill in the art will recognize that the same techniques may be used in other contexts and with respect to devices, libraries, and media other than those discussed in detail herein.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for managing media in an environment comprising two or more library, device, or host types, comprising:
sending to an agent installed at a host a media management request not specific to any library, device, or host type;
wherein the agent is configured to receive the request and act thereon in the manner required by the particular library, device, and/or host implicated by the request.

2. The method of claim 1, wherein said media management request requires action by said host.

3. The method of claim 1, wherein said media management request requires information about said host.

4. The method of claim 1, wherein said media management request requires information about a device associated with said host.

5. The method of claim 1, wherein said host comprises a first host and said media management request requires action by a second host with respect to which the agent installed at said first host acts as a communications surrogate.

6. The method of claim 1, wherein said media management request requires action by a device associated with said host.

7. The method of claim 1, wherein said media management request requires action by a library associated with said host.

8. The method of claim 1, further comprising receiving a media resource request requiring that an operation be performed with respect to a selected volume of said media.

9. The method of claim 8, wherein said media management request comprises a request that said operation be performed by a device specified in the request.

10. The method of claim 8, wherein said media management request comprises a request that said operation be performed by a library associated with said selected volume.

11. The method of claim 1, further comprising installing said agent at said host.

12. The method of claim 11, wherein installing said agent at said host comprises conditional compilation.

13. The method of claim 1, further comprising providing said agent to be installed at said host.

14. The method of claim 1, wherein said media management request is a request defined by a common interface for communicating with libraries, devices, and/or hosts of different types.

15. The method of claim 14, further comprising defining said common interface.

16. The method of claim 14, wherein said common interface comprises a request in a common format not specific to any library, device, or host type that corresponds to a type of request common to two or more library-, device-, and/or host-specific protocols.

17. The method of claim 1, further comprising receiving an identification of said host.

18. The method of claim 1, further comprising establishing communication with said host.

19. The method of claim 1, further comprising receiving an information request and wherein said media management request comprises a request for the information sought by said information request.

20. The method of claim 19, wherein said information request is received from a backup application program.

21. The method of claim 19, wherein said information request is received from a media management application.

22. The method of claim 19, wherein said information request is received via a user interface.

23. A system for managing media in an environment comprising two or more library, device, or host types, comprising:
a processor configured to send to an agent installed at a host a media management request not specific to any library, device, or host type; and
a network connection configured to transmit said media manage request to said host via a network on which said host is a node;
wherein the agent is configured to receive the request and act thereon in the manner required by the particular library, device, and/or host implicated by the request.

24. A computer program product for managing media in an environment comprising two or more library, device, or host types, the computer program product being embodied in a computer readable medium and comprising computer instructions for:
sending to an agent installed at a host a media management request not specific to any library, device, or host type;
wherein the agent is configured to receive the request and act thereon in the manner required by the particular library, device, and/or host implicated by the request.
